(19) United States
(12) Patent Application Publication
(10) Pub. No.: US 2006/0110657 A1
(43) Pub. Date: May 25, 2006

(54) Battery assembly for use in an uninterruptible power supply system and method

(76) Inventors: William Stanton, Melbourne, FL (US); Nathan G. Woodard, Pasadena, CA (US)

Correspondence Address: PRITZKAU PATENT GROUP, LLC, 993 GAPTER ROAD, BOULDER, CO, 80303, US

(21) Appl. No.: 11/273,157

(22) Filed: Nov. 14, 2005

Related U.S. Application Data
(60) Provisional application No. 60/628,366, filed on Nov. 15, 2004.

(51) Int. Cl. H01M 10/50; H01M 2/10

(52) U.S. Cl. 429/120; 429/7; 429/96

(57) ABSTRACT

A battery includes a housing and at least one exposed terminal. A thermally conductive mechanism is positioned outside the housing but in close proximity to the terminal, defining a thermally conductive path from the terminal to a point further from the terminal. The mechanism can use thermally conductive brackets that may be electrically isolated from the battery terminals. A heat sink may be positioned to receive heat from the bracket. A heat pump can cooperate with the thermally conductive mechanism and the heat sink for aiding in the movement of heat. A heater can be positioned within the housing for heating the inside of the housing. The battery can be encased by an arrangement of vacuum insulated panels in a way which provides for forming an external electrical connection with the battery terminals. A backup battery assembly and associated uninterruptible power system are described for powering a primary load.

### RELATED APPLICATION

The present application claims priority from U.S. Provisional Patent Application Ser. No. 60/628,366, filed on Nov. 15, 2004, the disclosure of which is incorporated herein by reference in its entirety.

### BACKGROUND

Batteries are used extensively to maintain power when the utility power is down. Standby power and Uninterruptible Power Supplies applications include central telephone offices, wire-line remote terminals, fiber-optic terminals, cable-television power, and cellular telephone repeaters. Lead acid batteries of two types, Valve Regulated Lead Acid (VRLA) and flooded-cell, dominate these applications. The flooded-cell, lead-acid batteries used in central telephone offices have been remarkably successful; life of 20 years has not been unusual. To achieve these lifetimes, flooded-cell, batteries are housed in air-conditioned rooms where the temperature is maintained in the range of 75° F. (Fahrenheit), the specific gravity of the electrolyte in each battery is monitored and corrected as necessary, terminal connections are checked and maintained, voltages for charge and float are checked and adjusted, discharge characteristics are tested and evaluated, and, most important of all, water is replaced in the cells as required.

The growth in business in industrial parks and the shift of residences to the suburbs outside of the city required high capacity communication networks to be built to serve these new locations. This change resulted in communication switches being distributed throughout the network in unmanned facilities; often metal cabinets alongside the road. The concept of standby powering used in central offices was extended to these locations that were distributed throughout the neighborhoods. However, the flooded-cell batteries could not be used in these applications because of their maintenance requirements and because of the potential for pollution from a battery spill. A new type of lead-acid battery was developed that did not require the replacement of water and in which the electrolyte was held in suspension so that it could not be spilled in the case of an accident. This battery is called the Valve Regulated Lead Acid Battery. There are two types of VRLA batteries, the Gel Cell and the Absorbent Glass Matt. In the first, the electrolyte is in a gelled state. In the second, the electrolyte is absorbed in tiny holes in layers of glass matt. In both types, the electrolyte is “captured” so that it cannot leak if the battery is tipped or punctured. In terms of attempting to protect batteries from heat and cold, the prior art includes placing a battery or multiple batteries into thermally controlled and/or insulated boxes.

Most of the batteries in these distributed applications are in metal cabinets that are exposed to high and low temperatures. Where exposed to high temperatures, even in a thermally insulated box, though to a lesser extent, these batteries have had useful lives much shorter than their design lives, and when exposed to low temperatures, the capacity of the battery is reduced.

The present invention resolves the foregoing limitations and concerns with the batteries recited above as well as other batteries displaying these deficiencies while providing still further advantages.

### SUMMARY OF THE DISCLOSURE

In accordance with one aspect of the present disclosure, a battery including a housing and at least one terminal extending out of the housing is described. A thermally conductive mechanism is positioned outside the housing but in sufficiently close proximity to the terminal and configured in a way which defines a thermally conductive path outside the housing from a point proximate the terminal to a point further from the terminal. In one embodiment of this battery assembly, the thermally conductive mechanism is comprised of at least one thermally conductive bracket that may be electrically isolated from one or both battery terminals. In this same embodiment a heat sink may be positioned in sufficiently close proximity to the further point defined by the thermally conductive path so as to receive heat reaching the last-mentioned point as it passes from the terminal along the path. Again, in this particular embodiment, a heat pump can be provided to cooperate with the thermally conductive mechanism and the heat sink for aiding in the movement of heat from the terminal to the heat sink. Moreover, a heater can be positioned for heating the battery. Further, an arrangement of vacuum insulated panels can define a thermally isolated interior which receives the battery in a way which provides for forming an external electrical connection with the battery terminals. In one feature, the battery terminals and at least a portion of the thermally conductive bracket is within the thermally isolated interior.

In accordance with another aspect of the present disclosure, there is described an overall battery assembly which includes a battery having a housing and an arrangement of components mounted with and carried by the battery housing. These components include a cooling mechanism and a heating mechanism configured so as to keep the temperature within the battery housing within a desired temperature range. In one embodiment, the cooling mechanism includes a thermally conductive bracket, a heat sink and a heat pump and the heating mechanism includes a heater.

In accordance with another aspect of the present disclosure, there is described a backup battery assembly for use in an overall uninterruptible power system which includes a primary power supply for powering a primary load. The backup battery assembly itself includes a backup battery (i) adapted for connection with the primary power supply so that the primary power supply is able to recharge the backup battery and (ii) adapted for connection with the primary load so that the backup battery is able to power the primary load when the primary power supply is unable to do so. The assembly also includes an arrangement connected with and powered by the backup battery for causing heat to move away from the battery whereby to cool down the battery, the arrangement including a sensor for sensing when the battery is being used to power the primary load and circuitry for insuring that the arrangement does not use power from the battery to cause heat to move away from the battery when the battery is being used to power the primary load. In one embodiment, the arrangement includes circuitry for insuring that the arrangement causes heat to move away from the battery at least when the battery is first recharged after being used to power the primary load, whereby to cool down the battery during recharging.

In accordance with still another aspect of the present disclosure, there is described an uninterruptible power system for powering a primary load. This system includes a primary power supply for powering the primary load and a backup battery (i) connected with the primary power supply so that the primary power supply is able to recharge the backup battery and (ii) connected with the primary load so that the backup battery is able to power the primary load when the primary power supply is unable to do so. An arrangement is connected with and powered by the backup battery for causing heat to move away from the battery for cooling down the battery and this arrangement includes a sensor for sensing when the battery is being used to power the primary load and circuitry for insuring that the arrangement does not use power from the battery to cause heat to move away from the battery when the battery is being used to power the primary load. Again, in one embodiment, the arrangement includes circuitry for insuring that the arrangement causes heat to move away from the battery at least when the battery is first recharged after being used to power the primary load so as to cool down the battery during recharging.

In each of these aspects of the present disclosure, the battery assembly according to one embodiment thereof is integrated to the extent that the various components making it up, for example, the thermally conductive bracket, the heat sink and the heat pump and heater are all mounted with the battery itself such that the overall assembly is portable.

### DESCRIPTION OF THE DRAWINGS

FIG. 1 diagrammatically illustrates, in perspective view, a battery assembly designed in accordance with one embodiment of the present disclosure, specifically one which uses a single thermally conductive bracket for directing heat away from both of the terminals of the battery.

FIG. 2 diagrammatically illustrates, in perspective view, a battery assembly designed in accordance with another embodiment of the present disclosure, specifically one which uses different thermally conductive brackets for directing heat away from one terminal of the battery.

FIG. 3 diagrammatically illustrates, in cross-sectional view, a battery assembly designed in accordance with either of the embodiments of the present disclosure, as illustrated in FIGS. 1 and 2 above, the cross-sectional view specifically depicting vacuum insulated panels encasing the battery assembly housing.

FIG. 4 diagrammatically illustrates, in enlarged cross-sectional view, the overall cooling arrangement forming part of the battery assembly designed in accordance with the embodiments shown in FIGS. 1 and 2.

FIG. 5 diagrammatically illustrates by means of block diagram the overall cooling arrangement forming part of the battery assembly designed in accordance with the embodiments shown in FIGS. 1 and 2.

FIG. 6 diagrammatically illustrates by means of block diagram an overall uninterruptible power system designed in accordance with the present disclosure.

FIG. 7 is a diagrammatic, perspective view of another embodiment of a battery assembly designed in accordance with the present disclosure.

FIG. 8 is a diagrammatic, partially cross-sectional view, in elevation, of the battery assembly of FIG. 7, shown here to illustrate further details of its structure.

### DETAILED DESCRIPTION

The following description is presented to enable one of ordinary skill in the art to make and use the invention and is provided in the context of a patent application and its requirements. Various modifications to the described embodiments will be readily apparent to those skilled in the art and the generic principles herein may be applied to other embodiments. Thus, the present invention is not intended to be limited to the embodiment shown but is to be accorded the widest scope consistent with the principles and features described herein including alternatives, modifications and equivalents, as defined within the scope of the appended claims. It is noted that the drawings are not to scale and are diagrammatic in nature in a way that is thought to best illustrate features of interest. Further, like reference numbers are applied to like components, whenever practical, throughout the present disclosure. Descriptive terminology has been adopted for purposes of enhancing the reader's understanding, with respect to the various views provided in the figures, and is in no way intended as being limiting.

As will become apparent hereinafter, the advantages that are provided by the various embodiments of the present invention include, but are not limited to:

1. Improving the life and reliability of VRLA batteries by providing practical, cost effective, self-contained, temperature-control configurations for these batteries.

2. Implementing temperature control arrangements so that:
a. The volume of the thermally controlled battery is minimally increased by the application of insulation
b. The thermally controlled battery can be purchased, stored, installed, operated, maintained, and disposed in the same manner as the existing VRLA battery
c. The thermally controlled battery cost will be acceptable to customers.

Features used to implement the invention include:
a. The application of Vacuum Insulated Panels to batteries to provide high levels of insulation in a very small volume.
b. The cooling of the battery through the terminals to gain better control of the internal temperature of the battery
c. In one embodiment, the thermal coupling of the electrical terminals of the VRLA battery to minimize internal temperature gradients by using a thermal conductor and the control of the temperature of those terminals using a cooler such as, for example, a thermoelectric type.

These features, when used as described herein, provide temperature control of a battery with a minimum volume of insulation, provide an integral temperature controller requiring no change in the basic operational paradigms, and provide effective temperature control of the battery to achieve improvements in reliability and life. Conduction of heat through the terminals and the coupling of the terminals thermally are considered to provide sweeping advantages over the prior art. In this way, the temperature of the grid structure of VRLA batteries is well controlled with a minimum of thermal gradients. The use of one or both terminals should be based on certain factors which are described in detail below.

Using the features set forth above, as described, a battery is provided with its own self-contained refrigerator. Similar to home refrigerators, the volume used to insulate the refrigerated space must be minimized so that usable volume is maximized. In addition, the insulation must have high thermal resistance to minimize the heat that must be removed from the battery. Heat conducted into the battery must be minimized because the more heat that has to be removed, the higher the power required to pump the heat. Ideally, one wants the power used to pump heat to approach zero, since any power used to pump the heat is power that is not available for the intended application. The VIPCell™ battery concept addresses these design goals by using Vacuum Insulated Panels as the insulation material. Next to vacuum itself, vacuum insulated panels have the highest levels of thermal resistance per unit of thickness. By using an adequate thickness of this material, the heat flow is reduced such that the power required to pump excess heat, whereby to keep the battery cool (or warm, in some instances), is acceptable.

As a further aspect of the invention, it is recognized that, in most applications, cooling of the battery can be shut-off when the battery is supplying power. This is possible for two reasons. First, because the time that the battery will be supplying power is short compared to its life, it is permissible for the battery temperature to rise during that relatively short time without it having a significant affect upon its life. Second, since the thermal time constant for the insulated battery, as taught herein, is very long, often on the order of one to two days, the battery temperature will only rise by a relatively small amount during the time that it is providing power; usually only hours or fractions of hours and, in any case, usually much shorter than a day.

Another benefit of integral temperature control, as taught herein, is achieved in that the life and reliability of a battery will not only be improved when used as an individual battery but will also be improved when used in series and parallel combinations, as is the case for most standby power and UPS (Uninterruptible Power System/Supply) applications. In these combinations, batteries are subject to thermal runaway during charging. This results, for example, from one of the batteries in a series string having a higher series resistance and therefore a higher voltage than the other batteries in the string. Since all of the batteries have the same current flowing through the string, the battery having higher resistance will have more power dissipated in it. All other effects being equal on the batteries, that battery will get hotter than the other batteries in the string. With increasing temperature, the series resistance of the hot battery will increase which will cause the battery to dissipate more power and get still hotter. If this condition is serious enough, it can lead to explosion. If less serious, the hot battery will be damaged over time and will lead to a shortened life for itself but also, unfortunately, for its companions. Integral temperature control prevents this problem in many battery applications, for example, by maintaining all of the batteries at a set temperature with small variance even with differences in dissipated power. Managing the temperature differences between batteries in strings can significantly reduce a known cause of shortened life and reduced reliability.

Thickness of insulation, levels of power to pump the heat, the amount of heat, the size of the heat sink all vary by battery size and power delivered. Tradeoffs between insulation thickness, size of heat sink, the use of fans, and the size of the thermoelectric cooler can be made to meet the requirements for specific types of applications. For example, batteries used to provide back-up power when utility power is not available can use utility power to pump the heat for most of the operating time since utility power is present most of the time. To minimize acquisition cost and maximize usable volume, the appropriate design trade-off is in the direction of lower amounts of insulation and higher amounts of power to pump the heat. In contrast, batteries used in conjunction with solar power would want to minimize the amount of heat to be pumped by increasing the insulation thickness and thereby reducing the “parasitic” power to pump heat. This is because reductions in total power required serve to reduce the size of the solar array. The concept of using Vacuum Insulated Panels to make integral temperature control of individual batteries feasible is considered to be applicable to any battery chemistry, so long as the contemplated benefits are achieved. For example, Lithium batteries, that prefer to operate at 40° C., can be insulated with Vacuum Insulated Panels to reduce the amount of heat required to keep them warm. Since lithium batteries need to be kept warm for both charge and discharge, minimization of the power required is highly desirable.

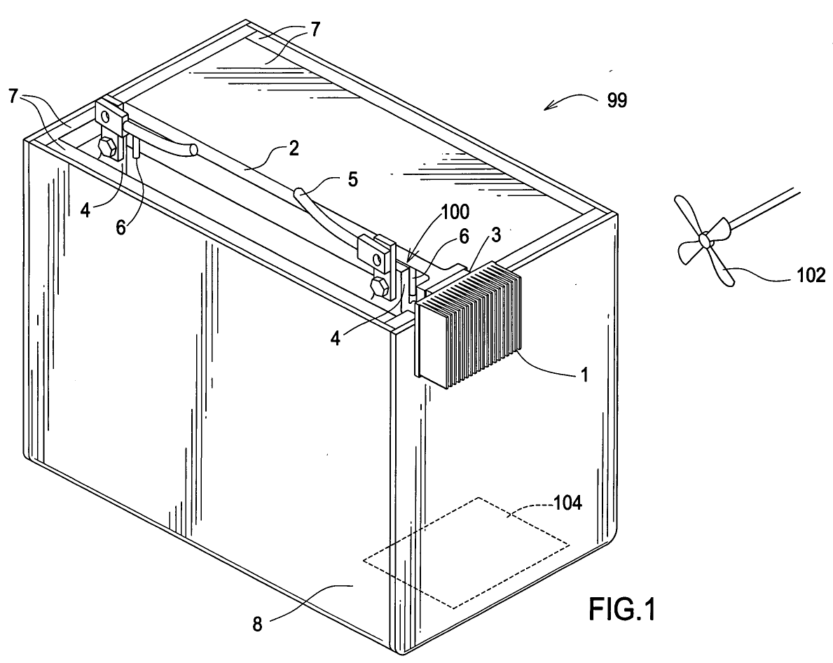

FIG. 1 is a drawing of one embodiment of a battery assembly 99 including a VRLA battery 100 (only the terminals of which are visible) that utilizes the Vacuum Insulated Panel (VIP) feature in conjunction with terminal thermal control and coupling features. It also uses thermoelectric cooling. In this drawing, Vacuum Insulated Panels, 7, are made to surround the housing tol of a traditional VRLA battery. A plastic case, 8, protects the Vacuum Insulated Panels from damage during handling and shipping. Bracket, 2, a thermal conductor, nominally aluminum but also possibly copper or any other suitable material having high thermal conductance either currently available or yet to be developed, couples the terminals and provides a low thermal resistance heat path from the internal grid structure to the thermal controller. An electrical insulator 6 which is generally thin and is also a good thermal conductor, may be formed of mica, but could be of any other suitable material or materials having similar characteristics, electrically separates battery terminal(s) 4, from bracket 2. Between bracket 2 and heat sink 1, is a thermoelectric cooler 3. When electrical power is applied to thermoelectric cooler 3 heat is pumped from the cold end, bracket 2, to the hot end, heat sink 1. Since the heat sink will be hotter than the surrounding air, heat will be transferred to the air through convection. Optionally, a fan (diagrammatically depicted at 102) can be included to increase the heat flow from heat sink 1 to the air in a manner that is familiar to those skilled in the art. Also, optionally, the heat sink could be replaced by a heat exchanger (not shown) using liquid flowing therethrough for remote dissipation of the heat. A battery cable 5 is shown for completeness. As another option, a cooling arrangement (e.g., heat sink, thermoelectric cooler, etc.) can be provided at both ends of elongated bracket 2, although this should not generally be necessary.

Still referring to FIG. 1, battery assembly 99 is shown including a heater (depicted diagrammatically at 104 in FIG. 1) which is separate and distinct from the heat sink 1 and the thermoelectric cooler 3 and which is conveniently located within the battery housing 101 (or otherwise suitably placed) in order to provide heat to battery 100. In this way, as will be discussed in more detail below, should the temperature of the battery rise, the cooling arrangement will operate to cool the battery and should the temperature fall, the heater will operate to heat up the battery. In this way, the temperature of the battery can be maintained within a desired range. Incidentally, while it is true that the thermoelectric cooler functioning as a heat pump could be used to both heat and cool the battery, as a general rule, a separate heater would be more efficient in the heating mode than would be a heat pump.

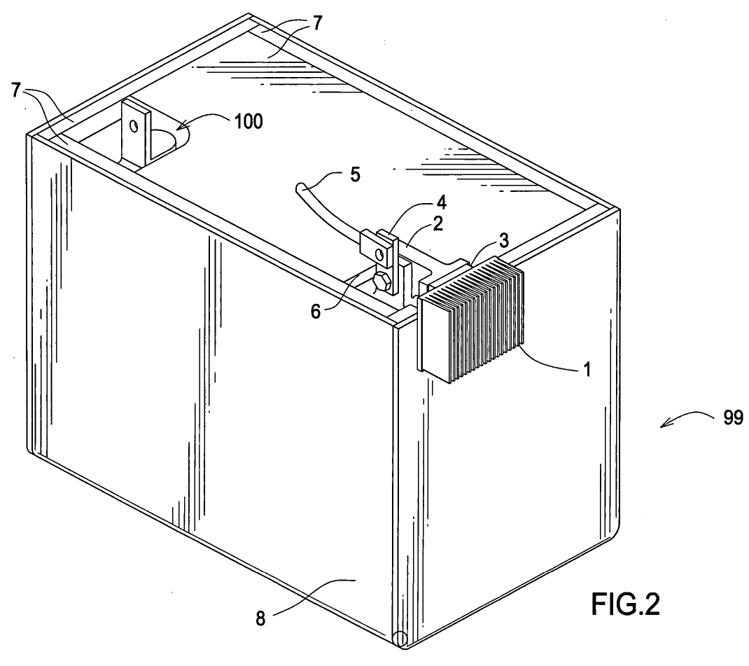

FIG. 2 is a drawing depicting a combination of vacuum insulated panels and thermal control of one terminal rather than the two terminals shown in FIG. 1. This implementation has special application for flooded cell lead acid batteries and other batteries with liquid electrolytes. Here, one relies on the thermal conductance of the liquid to conduct heat between the grids and to minimize the thermal gradients between them. In this application, electrical insulator 6 is optional inasmuch as it is permissible to allow thermal bracket 2 to float at the terminal potential. Of course, it should be appreciated that both terminals could be provided with a separate cooling arrangement, for example, when there is a concern to maximize electrical isolation between the terminals. Again, considering a choice between cooling one or both terminals, if the terminals are not well thermally coupled, for example, because there is no liquid electrolyte to connect the grids thermally, only the temperature of the grid structure connected to the controlled terminal is well maintained. The other terminal and other grid can, therefore, be at a much high higher temperature with a resulting, undesirably, large thermal gradient between the grids. Lack of temperature control and the presence of thermal gradients are known causes of shortened life and reduced reliability in VRLA batteries. Such thermal gradients can arise, for example, as a result of small differences in manufacturing that lead to different grid resistances and thermal resistances. These differences, in turn, result in different power dissipation leading to thermal gradients. It is noted that this phenomenon is more pronounced in VRLA batteries. While it is important to recognize the potential for these thermal gradients, it is noted that the primary issue is bulk battery temperature.

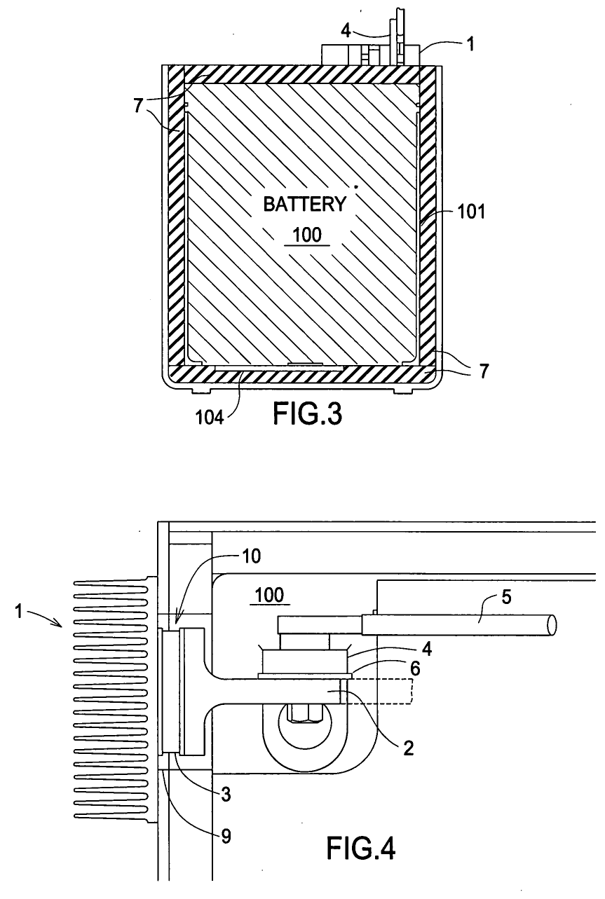

FIG. 3 is a cut-away end view of the insulated battery of either FIG. 1 or FIG. 2. Vacuum Insulated Panels 7 are depicted in roughly the expected proportions of volume of insulation to the volume of battery. Plastic case 8 is also depicted.

FIG. 4 is a further enlarged top view of the temperature controller arrangement of FIG. 2 shown to illustrate further details with respect to its structure. Further details of thermoelectric cooler 3 including a hot end 9 and a cold end 10 are depicted. Electrical insulator 6 is more easily recognized. Bracket 2 is shown for connection to a single terminal but would logically extend to the second terminal for application to VRLA batteries, as is partially illustrated using dashed lines.

In summarizing the various embodiments of battery assembly 99 thus far described, a battery 100 including a housing 101 and at least one terminal 4 extending out of the housing is described. A thermally conductive mechanism, for example bracket 2, is positioned outside the housing but in sufficiently close proximity to the terminal and configured in a way which defines a thermally conductive path outside the housing from a point proximate the terminal to a point further from the terminal. In one embodiment of battery assembly 99, the thermally conductive mechanism is a comprised of one or more thermally conductive brackets (that is, one or more brackets 2). In this same embodiment, heat sink 1 is positioned in sufficiently close proximity to the further point defined by the thermally conductive path so as to receive heat reaching the last-mentioned point as it passes from the terminal along the path. Again, in this particular embodiment, a heat pump, for example thermoelectric cooler 3, is provided to cooperate with the thermally conductive mechanism and the heat sink for aiding in the movement of heat from the terminal to the heat sink. Moreover, heater 104 is positioned for heating the battery through housing 101. Further, the housing can be encased by an arrangement of vacuum insulated panels 7 in a way which exposes the terminal to the ambient surroundings.

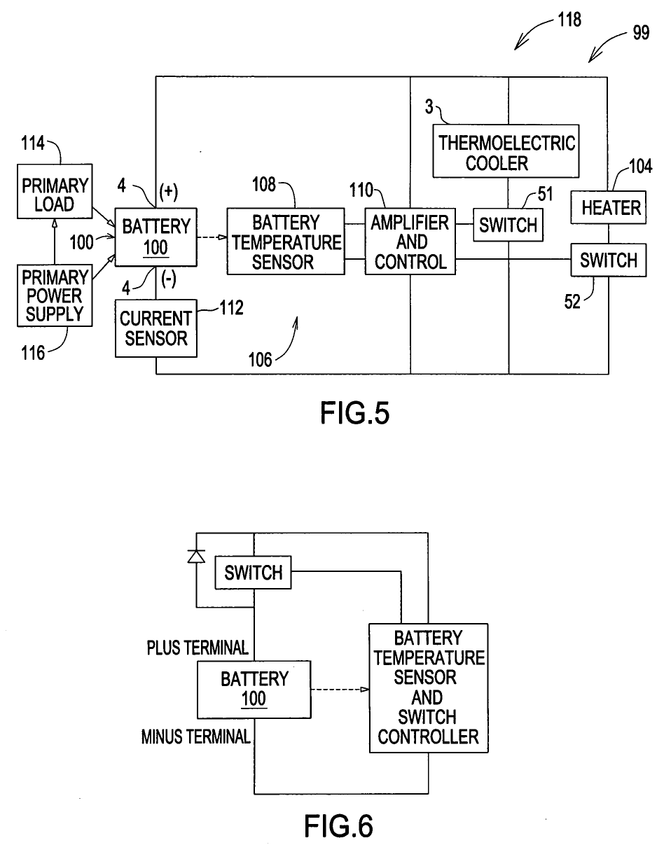

FIG. 5 is a block diagram illustrating a temperature controller 106 forming part of the overall battery assembly 99 which, as described above, includes battery 100, thermoelectric cooler, heater 104 and heat sink 1 (not shown in FIG. 5). The temperature controller 106 includes a temperature sensor 108 mounted on bracket 2 and appropriately positioned to sense the temperature of battery 100 within its housing 101. In a reduced accuracy, low cost form, the sensor 108 could be a thermostat. A more complex and more accurate temperature sensor, such as a thermistor, could be used in other applications. A control section 110 configured to cooperate with the particular type of sensor that is used, converts the sensed temperature into a control signal, for example a control voltage. When the voltage signal exceeds a threshold level indicating that the battery is unacceptably hot, switch S1 provides power to the thermoelectric cooler from battery 100 and pumps heat, as physically depicted in FIG. 1 (discussed above), from battery 100 through battery terminals 4 and through bracket 2 into heat sink 1 and from there into the air (see FIG. 1). For heating, when the voltage signal falls below a threshold level, the control section based upon these dropping temperature sensor signals, provides an appropriate signal to switch S2 to provide power to the heater 104. The insulated battery with integral thermal control is self-contained with electrical power provided by the battery for measuring, amplifying, thermoelectric cooling, and/or heating.

The temperature control methodology, referred to above, can be non-linear, linear, or pulse width modulation. Nominally, temperature is controlled with the thermoelectric cooler 3 and heater 104 to keep the battery between 20° C. and 25° C., for a VRLA, when the temperature of the environment is hotter than 25° C. and between 0° C. and 10° C. when colder than 0° C. If a Digital Signal Processor, or equivalent, is used as the control section 110, then an optional battery current sensor, generally indicated at 112 in FIG. 5, can be provided to shut off the thermoelectric cooler when the battery is delivering power to a primary load 114 which would normally be powered by a primary power supply 116.

Indeed, regardless of the details of control section 110, it can be configured with a current sensor 112 in accordance with the present invention (i) to sense when battery 100 is and is not discharging (delivering power to the primary load) and, during that time, (ii) to disconnect (or otherwise de-activate) the thermoelectric cooler from the battery so the battery does not have to deliver power to both the primary load and the thermoelectric cooler. Moreover, control section 110, in accordance with this particular embodiment, may be provided with circuitry to automatically reconnect (or re-activate) the thermoelectric cooler as soon as sensor 112 senses that the battery is no longer discharging. At that time, more than likely, primary power source 116 will be charging the battery and this charging operation is made more efficient if the battery is cooler rather than hotter. For that reason and the fact that the battery will have more than likely heated up during the discharge (power delivery) cycle (with the cooler de-activated), it is important to re-activate the cooler.

The overall battery assembly 99 described immediately above in conjunction with FIG. 5 may actually serve as part of an overall uninterruptible power system 118 which also includes the primary load and the primary power supply and suitable switching (not shown) for connecting the battery to the primary load for powering the latter and, alternatively to the primary power source for charging. This uninterruptible power system 118 includes the primary power supply 116 for powering the primary load 114; battery assembly 99 including backup battery 100 (i) connected with the primary power supply so that the primary power supply is able to recharge the backup battery and (ii) connected with the primary load so that the backup battery is able to power the primary load when the primary power supply is unable to do so. Moreover, there is provided an arrangement of components connected with and powered by the backup battery for causing heat to move away from the battery whereby to cool down the battery. This arrangement of components includes a sensor for sensing when the battery is being used to power the primary load and circuitry for insuring that the arrangement does not use power from the battery to cause heat to move away from the battery when the battery is being used to power the primary load. In addition, the arrangement may include circuitry for insuring that the arrangement causes heat to move away from the battery at least when the battery is first recharged after being used to power the primary load, whereby to cool down the battery during recharging.

FIG. 6 is a block diagram of a smart charging controller 120. In one implementation, the battery temperature is sensed and when an over-temperature condition is determined, the switch 102, typically a JFET or MOSFET, is opened and no additional charging current can flow into the battery. In this manner, thermal runaway is prevented and provides a redundant protection for the case of a failed cooling controller. If the controller is implemented with a Digital Signal Processor (DSP), it is possible to vary the resistance of the switch to control the charging current. To do this requires optional battery voltage and current sensors. Such sensors are well known to those skilled in the art and, hence, have not been illustrated. Accordingly, it is considered that these features can be implemented by those having ordinary skill in the art in view of this overall disclosure. The diode 104 provides a battery discharge path even if the switch is open; i.e., the battery can discharge even if it is hot. It is recognized that discharge when hot is acceptable because there is no risk of thermal runaway. It should noted that one DSP can provide all of the contemplated control functions. One suitable DSP is the TMS320LF2401A from Texas Instruments.

Having described the present invention in detail above, it will be appreciated that the concepts herein are thought to resolve problems that have never been addressed in an effective way. The associated benefits should not be taken lightly, particularly from an environmental standpoint. That is, considering the vast and ever increasing number of VRLA batteries in backup power use, the application of the present invention will provide a battery that will reach its design life under hostile environmental conditions, whereas a prior art battery that is subjected to these conditions may have a life that is one-half or less than its rated design life. Thus, there can be a significant reduction, for example, in lead pollution resulting from manufacturing activities.

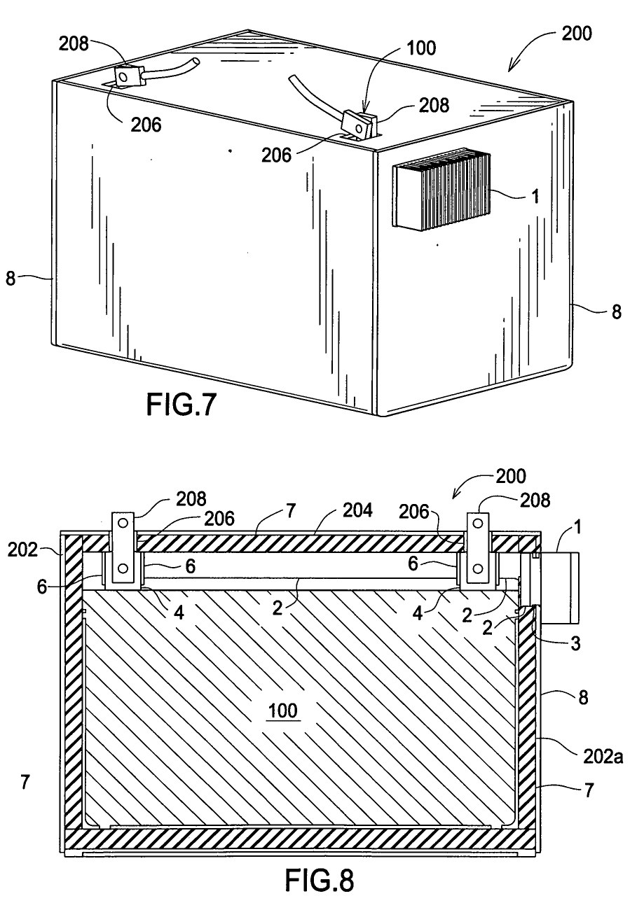

Attention is now directed to FIGS. 7 and 8 which illustrate another embodiment of a battery assembly that is generally indicated by the reference number 200. FIG. 7 shows assembly 200 in a diagrammatic perspective view, while FIG. 8 shows assembly 200 in a diagrammatic elevational view in partial cross-section. Battery 100 is encased by an arrangement of Vacuum Insulated Panels 7 which define a thermally isolated interior that receives the battery. In the present example, side VIPs 202 support an upper VIP 204 above terminals 4. An end panel VIP 202a has been partially cut-away, in the view of the figure, to reveal certain details. In particular, panel 202a defines an aperture that receives one end of bracket 2 in a way which can position the cold end of thermoelectric cooler 3 at least generally within the thickness of panel 202a. The hot end of thermoelectric cooler 3 is accessible from the exterior of the enclosure defined by the Vacuum Insulated Panels for purposes of supporting heat sink 1 in thermal communication therewith. As one alternative, the flanged end of bracket 2 can be positioned outward with respect to panel 202a which would reduce the size of the associate aperture in VIP 202a. Upper VIP 204 defines a pair of through openings 206 that are sized to receive a pair of electrically conductive links 208, each of which is electrically connected to one of the terminals of the battery. It should be appreciated that through openings 206 can be sized to provide a tight clearance fit around links 208, if so desired, to further improve thermal isolation of the battery from the ambient environment. In any case, irrespective of a particular clearance fit of link 208 within opening 206, any suitable thermally insulative material may be positioned in opening 206 between each link 208 and the surrounding sidewalls of VIP 204 such as, for example, expansive form, fiberglass or thermal grease. It should also be appreciated that the use of links 208 can provide for through openings 206 to be of a size that is smaller than battery terminal 4. That is, battery terminal 4 may be too large to fit into opening 206.

Moreover, it is to be understood that the various individual components making up the overall uninterruptible power system generally and the battery assembly in particular are by themselves readily providable by those with ordinary skill in the art in view of the teachings herein. Those components include, for example, the thermally conductive bracket 2, the thermoelectric cooler 3, the heat sink 1, the vacuum insulated panels 7 and the circuitry associated with the block diagrams of FIGS. 5-6 as well as functioning equivalents of those components.

Although each of the aforedescribed physical embodiments have been illustrated with various components having particular respective orientations, it should be understood that the present invention may take on a variety of specific configurations with the various components being located in a wide variety of positions and mutual orientations. Furthermore, the methods described herein may be modified in an unlimited number of ways, for example, by reordering the various sequences of which they are made up. Therefore, the present examples are to be considered as illustrative and not restrictive, and the invention is not to be limited to the details given herein but may be modified within the scope of the appended claims.

What is claimed is:

1. A battery assembly, comprising:
(a) a battery including a housing and at least one terminal extending out of said housing; and
(b) a thermally conductive mechanism positioned outside said housing but in sufficiently close proximity to and electrically isolated from said terminal and configured in a way which defines a thermally conductive path outside said housing from a point proximate said terminal to a point further from the terminal.

2. A battery assembly according to claim 1 including a heat sink positioned in sufficiently close proximity to said further point defined by said thermally conductive path so as to receive heat reaching said last-mentioned point as it passes from said terminal along said path.

3. A battery assembly according to claim 2 including a heat pump cooperating with said thermally conductive mechanism and said heat sink for aiding in the movement of heat from said terminal to said heat sink.

4. A battery assembly according to claim 3 including a heater positioned within said housing for heating the inside of the housing.

5. A battery assembly according to claim 1 wherein said thermally conductive mechanism includes at least one thermally conductive bracket extending from said point proximate said terminal to said further point.

6. A battery assembly according to claim 1 wherein said battery includes a second terminal and wherein said thermally conductive mechanism is positioned in sufficiently close proximity to said second terminal and configured in a way which defines a thermally conductive path outside said housing from a point proximate said second terminal to a point further from the second terminal.

7. A battery assembly according to claim 6 wherein said first mentioned and second mentioned further points are the same point and wherein said thermally conductive mechanism includes a single thermally conductive bracket extending from said points proximate said first mentioned and second terminals to said same further point.

8. A battery assembly according to claim 6 wherein said first mentioned and second mentioned further points are different points and wherein said thermally conductive mechanism includes separate first and second thermally conductive brackets respectively extending from said first mentioned and second points proximate said first mentioned and second terminals to said different further point.

9. A battery assembly according to claim 3 wherein said heat pump is a thermoelectric cooler.

10. A battery assembly according to claim 2 wherein said heat sink is mounted with and carried by said housing.

11. A battery assembly according to claim 3 wherein said heat sink and said heat pump are mounted with and carried by said housing.

12. A battery assembly according to claim 1 including an arrangement of vacuum insulated panels encasing said battery housing to provide for forming an external electrical connection with said terminal.

13. A battery assembly, comprising:
(a) a battery including a housing and at least one terminal extending out of said housing; and
(b) a thermally conductive mechanism positioned outside said housing but in sufficiently close proximity to said terminal and configured in a way which defines a thermally conductive path outside said housing from a point proximate said terminal to a point further from the terminal; and
(c) an arrangement cooperating with said thermally conductive mechanism for collecting heat at said further point.

14. A battery assembly according to claim 13 wherein said arrangement includes a heat sink.

15. A battery assembly, comprising:
(a) a battery including a housing and at least one terminal extending out of said housing; and
(b) a thermally conductive mechanism positioned outside said housing but in sufficiently close proximity to said terminal and configured in a way which defines a thermally conductive path outside said housing from a point proximate said terminal to a point further from the terminal; and
(c) an arrangement cooperating with said thermally conductive mechanism for dispersing heat at said further point.

16. A battery assembly according to claim 15 wherein said arrangement includes a fan.

17. A battery assembly, comprising:
(a) a battery including a housing and a pair of terminals extending out of said housing;
(b) an arrangement of vacuum insulated panels defining a thermally isolated interior that receives said battery in a way which provides for forming an external electrical connection with said terminals
(c) at least one thermally conductive bracket mounted with and carried by said battery and positioned in sufficiently close proximity to said terminal and configured in a way which defines a thermally conductive path extending out of said thermally isolated interior from a point proximate said terminal to a point further from the terminal;
(d) a heat sink mounted with and carried by said battery and positioned in sufficiently close proximity to said further point defined by said thermally conductive path so as to receive heat reaching said last-mentioned point as it passes from said terminal along said path;
(e) a thermoelectric cooler mounted with and carried by said battery and cooperating with said thermally conductive mechanism and said heat sink for aiding in the movement of heat from said terminal to said heat sink; and
(f) a heater positioned proximate to said housing for heating the inside of the housing.

18. The assembly of claim 17 wherein said thermally conductive bracket is substantially within said thermally isolated interior.

19. The assembly of claim 17 wherein said pair of terminals and at least a portion of said thermally conductive bracket are within said thermally isolated interior.

20. A battery assembly, comprising:
(a) a battery including a housing and at least one terminal extending out of said housing; and
(b) a thermally conductive mechanism positioned outside said housing but in sufficiently close proximity to said terminal and configured in a way which defines a thermally conductive path outside said housing from a point proximate said terminal to a point further from the terminal; and
(c) a thermoelectric cooling device located proximate to said further point.

21. A battery assembly, comprising:
(a) a battery including a housing and at least one terminal extending out of said housing;
(b) means for thermally insulating said battery while providing access to said terminal for use in forming an electrical connection therewith;
(c) means defining a thermally conductive path outside said panels from a point proximate said terminal to a point further from the terminal;
(d) means for receiving heat reaching said last-mentioned point as it passes from said terminal along said path;
(e) means for aiding in the movement of heat from said terminal to said receiving means; and
(f) means for heating the inside of the housing.

22. A battery assembly, comprising:
(a) a battery including a housing; and
(b) an arrangement of components mounted with and carried by the battery housing including a cooling mechanism and a heating mechanism configured so as to keep the temperature within the battery housing within a desired temperature range.

23. A battery assembly according to claim 22 wherein said cooling mechanism includes a thermally conductive bracket, a heat sink and a heat pump and wherein said heating mechanism includes a heater.

24. In an uninterruptible power system which includes a primary power supply for powering a primary load, a backup battery assembly, comprising:
(a) a backup battery (i) adapted for connection with said primary power supply so that the primary power supply is able to recharge the backup battery and (ii) adapted for connection with said primary load so that the backup battery is able to power the primary load when said primary power supply is unable to do so;
(b) an arrangement connected with and powered by said backup battery for causing heat to move away from said battery to cool down the battery, said arrangement including a sensor for sensing when said battery is being used to power the primary load and circuitry for insuring that the arrangement does not use power from the battery to cause heat to move away from the battery when the battery is being used to power the primary load.

25. A battery assembly according to claim 24 wherein said arrangement includes circuitry for insuring that the arrangement causes heat to move away from said battery at least when said battery is first recharged after being used to power the primary load, whereby to cool down the battery during recharging.

26. An uninterruptible power system for powering a primary load, comprising:
(a) a primary power supply for powering said primary load;
(b) a backup battery (i) connected with said primary power supply so that the primary power supply is able to recharge the backup battery and (ii) connected with said primary load so that the backup battery is able to power the primary load when said primary power supply is unable to do so;
(c) an arrangement connected with and powered by said backup battery for causing heat to move away from said battery whereby to cool down the battery, said arrangement including a sensor for sensing when said battery is being used to power the primary load and circuitry for insuring that the arrangement does not use power from the battery to cause heat to move away from the battery when the battery is being used to power the primary load.

27. An uninterruptible power system according to claim 26 wherein said arrangement includes circuitry for insuring that the arrangement causes heat to move away from said battery at least when said battery is first recharged after being used to power the primary load, whereby to cool down the battery during recharging.

28. A method, comprising:
(a) providing a battery including a housing and at least one terminal extending out of said housing;
(b) thermally insulating said battery while providing for an external electrical connection with said terminal;
(c) defining a thermally conductive path from a point proximate said terminal to a point further from the terminal;
(d) selectively aiding in the movement of heat from said terminal to said further point; and
(e) receiving heat reaching said further point, after passing from said terminal along said path, for dissipation into an ambient environment.

29. The method of claim 28 further comprising:
(f) selectively heating the battery in cooperation with said selectively aiding.
